(19) United States
(12) Patent Application Publication
(10) Pub. No.: US 2010/0082700 A1
(43) Pub. Date: Apr. 1, 2010

(54) STORAGE SYSTEM FOR DATA VIRTUALIZATION AND DEDUPLICATION

(75) Inventor: Nitin Parab, Menlo Park, CA (US)

Correspondence Address: GENERAL - LAW OFFICE OF JONATHAN HOLLANDER PC, 660 4TH STREET #198, SAN FRANCISCO, CA, 94107, US

(73) Assignee: RIVERBED TECHNOLOGY, INC., San Francisco, CA (US)

(21) Appl. No.: 12/235,548

(22) Filed: Sep. 22, 2008

(51) Int. Cl. G06F 12/02

(52) U.S. Cl. 707/803; 707/E17.01; 711/E12.002

(57) ABSTRACT

A data virtualization storage appliance performs data deduplication transformations on the data. The original or non-deduplicated file system is used as shell to hold the directory/file hierarchy and file metadata. The data of the file system is stored by a separate data storage in a transformed and deduplicated form. The deduplicated data store may be implemented as one or more hidden files. The shell file system preserves the hierarchy structure and potentially the file metadata of the original, non-deduplicated file system in its original format, allowing clients to access file metadata and hierarchy information easily. The data of a file may be removed from the shell file system and replaced with a data layout that specifies the arrangement of deduplicated data segments needed to reconstruct the file data. The data layout associated with a file may be stored in a separate data stream in the shell file system.

### CROSS REFERENCE TO RELATED APPLICATIONS

This application is related to U.S. patent application Ser. No. 12/117,629, filed May 8, 2008, and entitled “Hybrid Segment-Oriented File Server and WAN Accelerator”; and U.S. patent application Ser. No. ______ [R000210US]______, filed ______ and entitled “Log Structured Content Addressable Deduplicating Storage,” both of which are incorporated by reference herein for all purposes.

### BACKGROUND

The present invention relates generally to data storage systems, and systems and methods to improve storage efficiency, compactness, performance, reliability, and compatibility. In computing, a file system specifies an arrangement for storing, retrieving, and organizing data files or other types of data on data storage devices, such as hard disk devices. A file system may include functionality for maintaining the physical location or address of data on a data storage device and for providing access to data files from local or remote users or applications. A file system may include functionality for organizing data files, such as directories, folders, or other container structures for files. Additionally, a file system may maintain file metadata describing attributes of data files, such as the length of the data contained in a file; the time that the file was created, last modified, and/or last accessed; and security features, such as group or owner identification and access permission settings (e.g., whether the file is read-only, executable, etc.).

Many file systems are tasked with handling enormous amounts of data. Additionally, file systems often provide data access to large numbers of simultaneous users and software applications. Users and software applications may access the file system via local communications connections, such as a high-speed data bus within a single computer; local area network connections, such as an Ethernet networking or storage area network (SAN) connection; and wide area network connections, such as the Internet, cellular data networks, and other low-bandwidth, high-latency data communications networks. Storage appliances allow clients access to store and retrieve data on a file system using network storage protocols, such as NFS, and CIFS. Storage appliances often build their file systems using raw disk interfaces to access disk storage systems.

A file system may support multiple data streams or file forks for each file. A data stream is an additional data set associated with a file system object. Many file systems allow for multiple independent data streams. Unlike typical file metadata, data streams typically may have any arbitrary size, such as the same size or even larger than the file's primary data. Each data stream is logically separate from other data streams, regardless of how it is physically stored. For files with multiple data streams, file data is typically stored in a primary or default data stream, so that applications that are not aware of streams will be able to access file data. File systems such as NTFS refer to logical data streams as alternate data streams. File systems such as XFS use the term extended attributes to describe additional data streams. Network File Protocols such as CIF and NFSv4 support naming, reading, writing, creating and deleting of additional data streams.

Storage virtualization appliances are storage front-ends that export virtual file systems that are built using storage appliances and accessed through file storage protocols. The storage virtualization may present the data and metadata of the file system to clients as a virtual file system, such that the underlying structure and arrangement of data and metadata is hidden from users and applications. The storage virtualization appliance intercepts and processes all client commands to the virtual file system, accesses and optionally updates the data and metadata in the underlying file data and metadata storage in the native file system, and optionally provides a result back to the users or applications. Many storage virtualization appliances do metadata virtualization wherein a virtual directory and files hierarchy is exported from one or more directory/file hierarchies. Such storage virtualization appliances my be referred as metadata virtualization appliance. A data virtualization storage appliance is an storage virtualization system that uses the file/directory hierarchy of exiting storage appliance but for clients' data write operations applies transformations to the data and stores the data in a format different than the format in which client sent the data and on read operations by the client sends the data to the client in client's original format applying transformation on the fly.

### BRIEF SUMMARY

An embodiment of the invention includes a data virtualization storage appliance that performs data deduplication transformations on the data. In an embodiment, the original or non-deduplicated file system is used as shell to hold the directory/file hierarchy and file metadata. In an embodiment, the data of the file system is stored by a separate data storage in a transformed and deduplicated form. In an embodiment, the deduplicated data store can be implemented as one or more hidden files. The shell file system preserves the hierarchy structure and potentially the file metadata of the original, non-deduplicated file system in its original format, allowing clients to access file metadata and hierarchy information easily.

In an embodiment, the data of a file is removed from the shell file system and replaced with a data layout that specifies the arrangement of deduplicated data segments needed to reconstruct the file data. In an embodiment, the data layout associated with a file may be stored in a separate data stream in the shell file system. In another embodiment, the data layout may be stored in the main data stream of the associated file in the original file system.

### BRIEF DESCRIPTION OF THE DRAWINGS

The invention will be described with reference to the drawings, in which:

FIG. 1 illustrates an example file system suitable for implementation with embodiments of the invention;

FIG. 2 illustrates an example arrangement of data and metadata of a file system according to an embodiment of the invention;

FIG. 3 illustrates updating data and metadata of a file system according to an embodiment of the invention;

FIGS. 4A-4C illustrate examples of deduplicating data storage according to an embodiment of the invention;

FIG. 5 illustrates a virtual file system stack suitable for implementing file systems according to embodiments of the invention;

FIGS. 6A-6C illustrate storing virtual file system layer data in additional file streams according to embodiments of the invention; and

FIG. 7 illustrates an example hybrid WAN acceleration and deduplicating data storage system suitable for use with embodiments of the invention.

In the drawings, the use of identical reference numbers indicates identical components.

### DETAILED DESCRIPTION OF ILLUSTRATIVE EMBODIMENTS

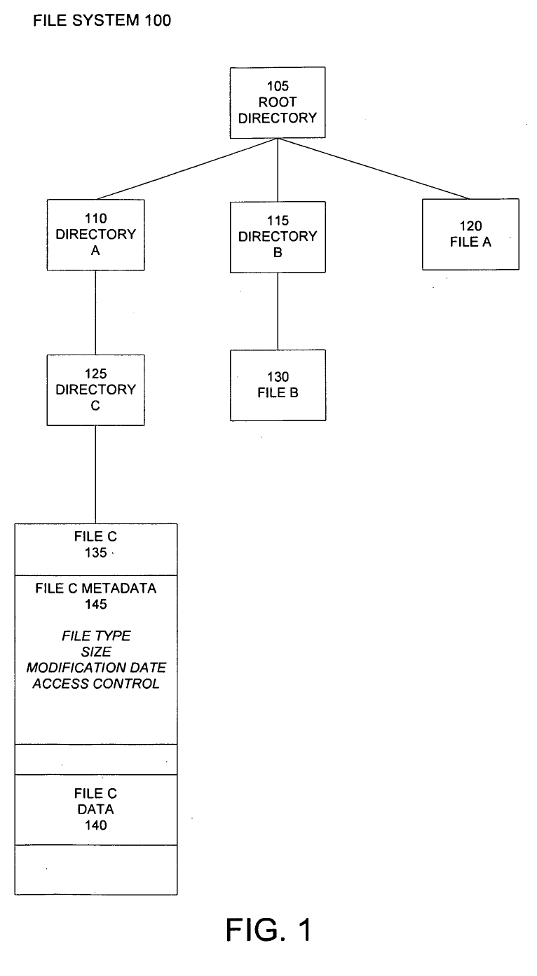

FIG. 1 illustrates an example file system 100 suitable for implementation with embodiments of the invention. File system 100 organizes files within a hierarchy of directories. For example, root directory 105 includes directories A 110 and B 115 as well as file A 120. Directory B 115 includes file B 130. Directory A 110 includes directory C 125. Directory C 125 includes file C 135. Each file may include file data and file metadata. File metadata is information maintained by the file system to describe the location and attributes of a file. For example, file C 135 includes file C data 140 and file C metadata 145. In this example, the file C metadata 145 includes data defining the file type, the file size, the file's most recent modification date, and access control parameters, such as granting or denying users or applications read and/or write access to the file.

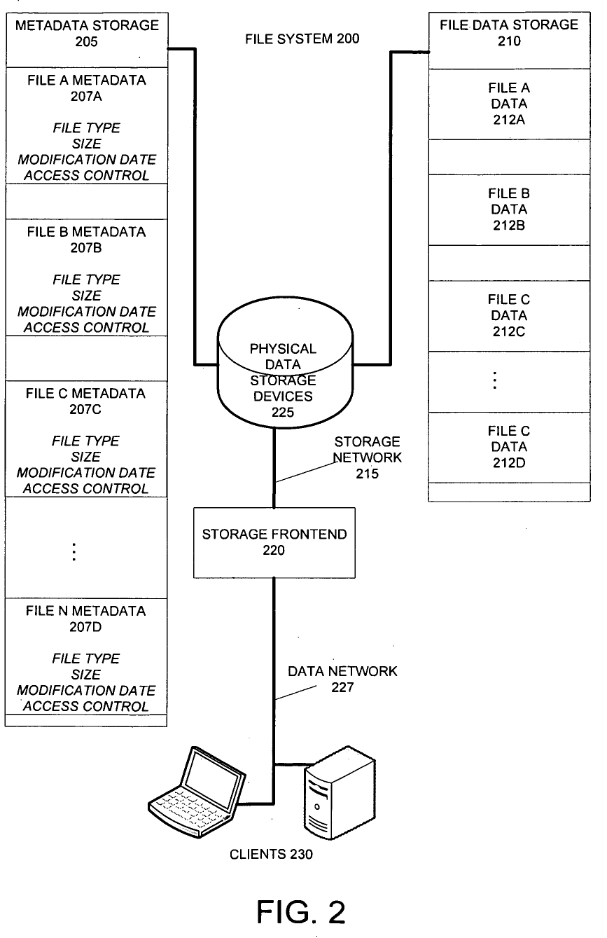

FIG. 2 illustrates an example arrangement of data and metadata of a file system 200 according to an embodiment of the invention. In file system 200, the file data and file metadata are stored in separate logical, and potentially physical, locations. This allows the file system 200 to scale more efficiently over large numbers of storage devices.

File system 200 includes metadata storage 205. Metadata storage 205 includes metadata 207 for all of the files and other objects, such as directories, aliases, and symbolic links, stored by the file system. For example, metadata storage 205 may store metadata 207a, 207b, and 207c associated with files A 120, B 130, and C 135 of file system 100 in FIG. 1, in addition to metadata 207d for any additional files or objects in the file system.

File system 200 also includes file data storage 210. File data storage 210 includes data 212 for all of the files and other objects, such as directories, aliases, and symbolic links, stored by the file system. For example, data storage 210 may store data 212a, 212b, and 212c associated with files A 120, B 130, and C 135 of file system 100 in FIG. 1, in addition to data 212d for any additional files or objects in the file system. The data 212 may be stored in its native format, as specified by applications or users, or, as described in detail below, the data 212 may be transformed, compressed, or otherwise modified to improve storage efficiency, file system speed or performance, or any other aspect of the file system 200.

Embodiments of metadata storage 205 and data storage 210 may each be implemented using one or more physical data storage devices 225, such as hard disks or hard disk arrays, tape libraries, optical drives or optical disk libraries, or volatile or non-volatile solid state data storage devices. Metadata storage 205 and data storage 210 may be implemented entirely or partially on the same physical storage devices 225 or may be implemented on separate data storage devices. The physical data storage devices 225 used to implement metadata storage 205 and data storage 210 may each comprise a logical storage device, which in turn is comprised of a number of physical storage devices, such as RAID devices.

The metadata storage 205 and data storage 210 are connected with storage front-end 220. In an embodiment, storage front-end 220 is connected with the physical storage devices 225 storing metadata storage 205 and data storage 210 via storage network 215. Storage network 215 may include Fibre Channel, InfiniBand, Ethernet, and/or any other type of physical data communication connection between physical storage devices 225 and the storage front-end 220. Storage network 215 may use any data communications or data storage protocol to communicate data between physical storage devices 225 and the front-end 220, including Fibre Channel Protocol, iFCP, and other variations thereof; SCSI, iSCSI, HyperSCSI, and other variations thereof; and ATA over Ethernet and other storage device interfaces.

The storage front-end 220 provides file system and data virtualization and is adapted to interface one or more client systems 230 with the data and metadata stored by the file system 200. In this example, the term client means any computer or device accessing the file system 200, including server computers hosting applications and individual user computers. A client 230 may connect with storage front-end via network connection 227, which may include wired or wireless physical data communications connections, for example Fibre Channel, Ethernet and/or 802.11x wireless networking connection, and may use networking protocols such TCP/IP or Fibre Channel Protocol to communicate with storage front-end 220.

The storage front-end 220 may present the data and metadata of the file system 200 to clients as a virtual file system, such that the underlying structure and arrangement of data and metadata within the metadata storage 205 and data storage 210 is hidden from clients 230. The virtual file system provided by storage front-end 220 presents clients 230 with a view of the file system data and metadata as a local or networked file system, such as an XFS, CIFS, or NFS file system. Because the storage front-end 220 presents a virtual file system to one or more clients 230, depending upon the file system protocol, a client may believe that it is managing files and data on a raw volume directly. The storage front-end 220 intercepts and processes all client commands to the virtual file system, accesses and optionally updates the data and metadata in the data storage 210 and metadata storage 205, and optionally provides a result back to the clients 230. In processing client commands to the virtual file system, the storage front-end may perform data processing, caching, data transformation, data compression, and numerous other operations to translate between the virtual file system and the underlying format of data in the data storage 210 and metadata storage 205.

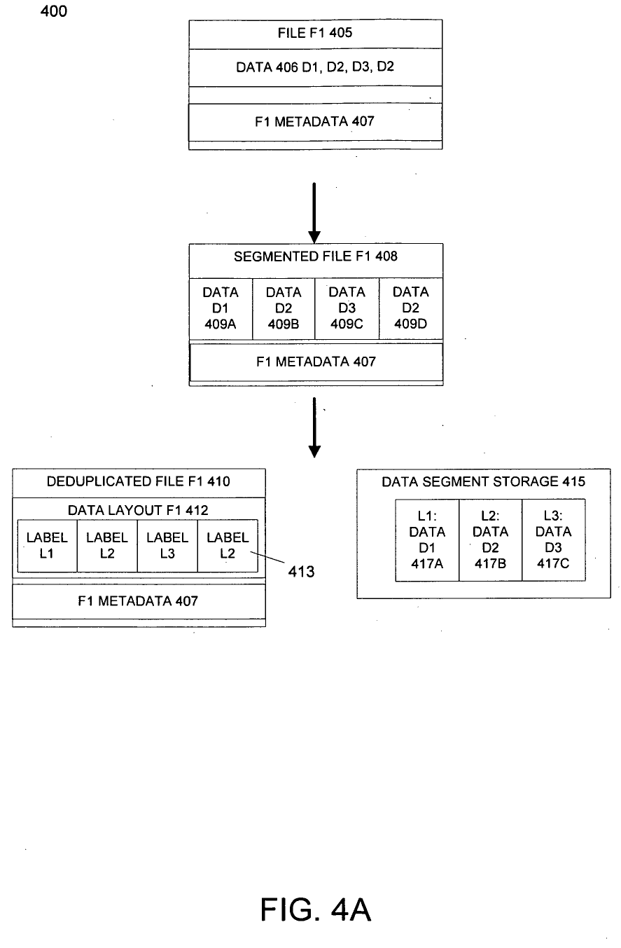

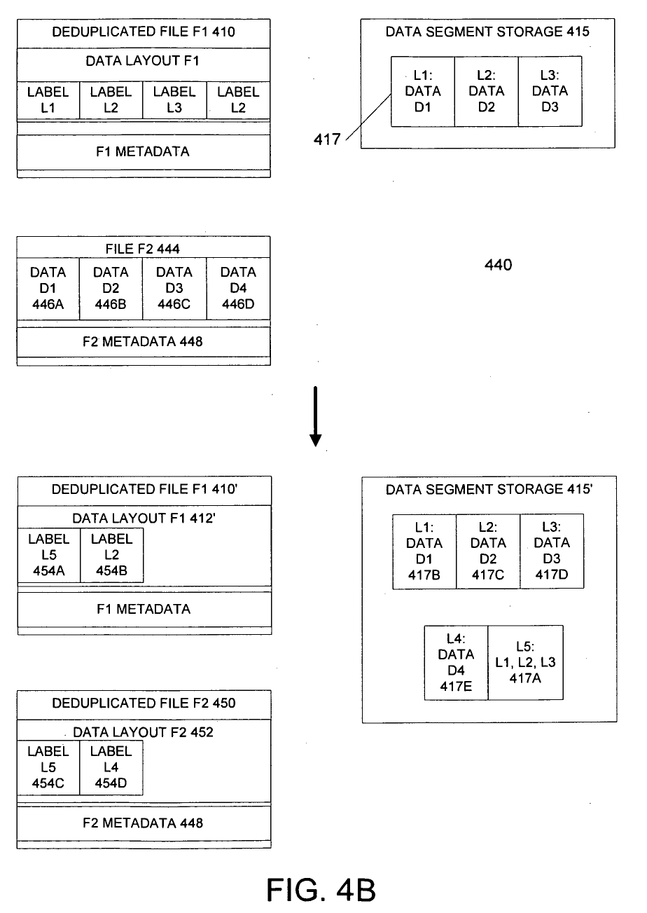

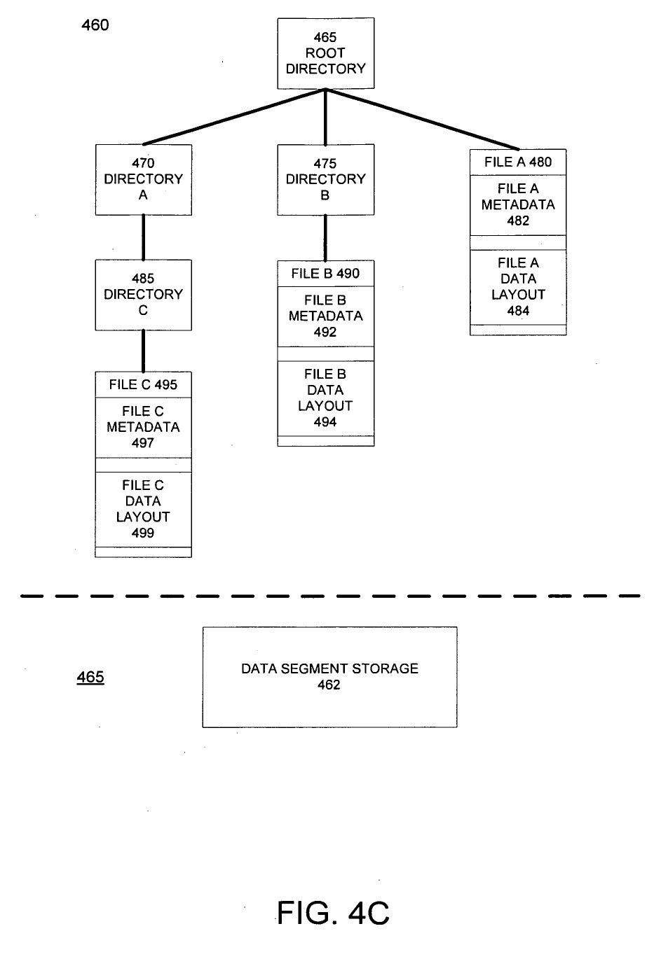

Data virtualization refers to any process or technique for converting data from its original format into a different format for more efficient storage, communication, or processing. Data virtualization also refers to any process or technique for converting virtualized data back to original format for users and applications. Data deduplication is one type of data virtualization that eliminates redundant data for the purposes of storage or communication. To reduce the storage capacity requirements and improve file system performance, embodiments of the invention may be used with a deduplicating file system that reduces redundant data stored within a single file or over many files. FIGS. 4A-4C illustrate examples of deduplicating data storage according to an embodiment of the invention.

FIG. 4A illustrates an example 400 of a deduplicating file storage suitable for use with an embodiment of the invention. A file F1 405 includes file data 406 and file metadata 407. In an embodiment, the file data 406 is partitioned or segmented into one or more segments based on factors including the contents of the file data 406, the potential size of a segment, and the type of file data. There are many possible approaches for segmenting data for the purposes of deduplication, some of which make use of hashes or other types of data characterizations. One such approach, which may make use of hashes in some embodiments, is the hierarchical segmentation scheme described in U.S. Pat. No. 6,667,700 entitled “Content-Based Segmentation Scheme for Data Compression in Storage and Transmission Including Hierarchical Segment Representation,” which is incorporated by reference herein for all purposes. Hierarchical schemes which make use of hashes may take on a number of variations according to various embodiments, including making use of hashes of hashes. In addition, many other segmentation schemes and variations are known in the art and may be used with embodiments of the invention.

Regardless of the technique used to segment file data 407, the result is a segmented file 408 having its file data represented as segments 409, such as segments 409a, 409b, 409c, and 409d in example 400. In example 400, segment 409a includes data D1 and segment 409c includes data D3. Additionally, segments 409b and 409d include identical copies of data D2. Segmented file 408 also includes the same file metadata 407 as file 405. In embodiments of the invention, file data segmentation occurs in memory and segmented file 408 is not written back to data storage in this form.

Following the segmentation of the file data 406 into file segments 409, each segment is associated with a unique label. In example 400, segment 409a representing data D1 is associated with label L1, segments 409b and 409d representing data D2 are associated with label L2, and segment 409c representing data D3 is associated with label L3. In an embodiment, the file F1 405 is replaced with deduplicated file F1 410. Deduplicated file F1 410 includes data layout F1 412 specifying a sequence of labels 413 corresponding with the data segments identified in the file data 406. In this example, the data layout F1 412 includes a sequence of labels L1 413a, L2 413b, L3 413c, L2 413d, corresponding with the sequence of data segments D1 409a, D2 409b, D3 409c, and a second instance of segment D2 409d. Deduplicated file 410 also includes a copy of the file metadata 407

A data segment storage 415 includes copies of the segment labels and corresponding segment data. In example 400, data segment storage 415 includes segment data D1, D2, and D3, and corresponding labels L1, L2, and L3. Using the data layout within a file and the data segment storage 415, a storage system can reconstruct the original file data by matching in sequence each label in a file's data layout with its corresponding segment data from the data segment storage 415.

As shown in example 400 of FIG. 4A, the use of data deduplication reduces the storage required for file F1 405, assuming that the storage overhead for storing labels 417 in the data layout 415 and data segment storage 415 is negligible. Furthermore, data deduplication can be applied over multiple files to further increase storage efficiency and increase performance.

FIG. 4B illustrates an example 440 of data deduplication applied over several files. Example 440 continues the example 400 and begins with deduplicated file F1 410 and data segment storage 415 as described above. Example 440 also includes a second file, file F2 444 including file metadata 448 and file data segmented into data segments D1 446a, D2 446b, D3 446c, and D4 446d. Data segments 446a, 446b, and 446c are identical in content to the data segments 409a, 409b, and 409c, respectively, discussed in FIG. 4A.

In an embodiment, the file F2 444 is replaced with deduplicated file F2 450. Deduplicated file F2 450 includes data layout F2 452 specifying a sequence of labels 454 corresponding with the data segments identified in the file data 446. In this example, the data layout F2 452 includes a sequence of labels L5 454c and L4 454d. Additionally, example 440 replaces deduplicated file F1 410 with a more efficient deduplicated file F1 410′. The deduplicated file F1 410′ includes data layout 412′ including labels L5 454a and L2 454b.

An updated data segment storage 415′ includes copies of the segment labels and corresponding segment data. In example 440, data segment storage 415′ includes segment data D1 and labels L1 417b, segment data D2 and label L2 417c, segment data D3 and label L3 417d, and segment data D4 and label L4 417e.

Additionally, in this example implementation of data deduplication, labels may be hierarchical. A hierarchical label is associated with a sequence of one or more additional labels. Each of these additional labels may be associated with data segments or with further labels. For example, data segment storage 415′ includes label L5 417a. Label L5 417a is associated with a sequence of labels L1, L2, and L3, which in turn are associated with data segments D1, D2, and D3, respectively. In other embodiments, labels or label-equivalents may be non-hierarchical.

Using the data layout within a file and the data segment storage 415′, a storage system can reconstruct the original file data of a file by recursively matching in sequence each label in a file's data layout with its corresponding segment data from the data segment storage 415′. For example, an storage system may reconstruct the data of file F2 444 by matching label L5 454c in data layout F2 452 with the sequence of labels “L1, L2, and L3” using label 417a in data segment storage 415′. The storage system then uses labels L1 417b, L2 417c, and L3 417d to reconstruct data segments D1 446a, D2 446b, and D3 446c in file F2. Similarly, label 454d in data layout F2 452 is matched to label 417e in data segment storage 415′, which reconstructs data segment D4 446d.

The data layouts and file system metadata of files in a deduplicating data storage system may be arranged in a number of ways. FIG. 4C illustrates one example of a deduplicating file system 460 according to an embodiment of the invention. File system 460 organizes files within a hierarchy of directories. For example, root directory 465 includes directories A 470 and B 475 as well as file A 480. Directory B 475 includes file B 490. Directory A 470 includes directory C 485. Directory C 485 includes file C 495.

In example file system 460, each file may include a file data layout and file metadata. As described above, file data layout specifies a sequence of labels representing data segments needed to reconstruct the original data of the file. For example, file A 480 includes file A data layout 484 and file C metadata 482, file B 490 includes file B data layout 494 and file B metadata 492, and file C 495 includes file C data layout 499 and file C metadata 497.

The data segment storage 462 exists as one or more separate files. In an embodiment, the data segment storage 462 is implemented as visible or hidden files on a separate logical storage partition or storage device. In a further embodiment, the data segment storage 462 is implemented in a manner similar to file data storage 210 discussed above. Additionally, the deduplicated file system 460 may be implemented, at least in part, using the metadata storage 205 discussed above.

In an embodiment, file data layout may be stored as the contents of the file.

A file system may support multiple data streams or file forks for each file. A data stream is an additional data set associated with a file system object. Many file systems allow for multiple independent data streams. Unlike typical file metadata, data streams typically may have any arbitrary size, such as the same size or even larger than the file's primary data. Each data stream is logically separate from other data streams, regardless of how it is physically stored. For files with multiple data streams, file data is typically stored in a primary or default data stream, so that applications that are not aware of streams will be able to access file data. File systems such as NTFS refer to logical data streams as alternate data streams. File systems such as XFS use the term extended attributes to describe additional data streams. Network file protocols such as CIFS and some versions of NFS also support additional data streams.

In an embodiment, the data layout of a deduplicated file may be stored in a separate data stream. The primary or default data stream of a file may be empty or contain other data associated with a file object. In this embodiment, the deduplicated file system is a “shell” of the original file system. The deduplicated file system preserves the hierarchy structure and potentially the file metadata of the original, non-deduplicated file system in its original format. However, the file data itself is removed from file objects and replaced with data layouts in a different data stream.

When an application or client attempts to read file data from a file system, an embodiment of a storage front-end intercepts the read request. This embodiment then accesses the data layout of the file from the appropriate data stream. Using the data layout, an embodiment of the storage front-end retrieves one or more data segments specified by the data layout to reconstructs all or a portion of the file data. This embodiment of the storage front-end then returns the reconstructed data satisfying the read request to the application or client.

Similarly, when an application or client attempts to write file data to a file system, an embodiment of the storage front-end intercepts the write request and the data to be stored. The storage front-end transforms the data to be stored into one or more data segments. The storage front-end may perform the data segmentation itself, or, as discussed in detail below, a WAN accelerator may optionally be leveraged to perform data segmentation. Unique labels for each data segment are generated. In an embodiment, the label is based on the contents of the data segment, for example using a hash function, so that data segments with identical data will have the same label.

An embodiment of the storage front-end then stores the data layout for the write data in the file system, for example in a separate data stream, and stores the associated data segments and labels in the data segment storage. In an embodiment, the storage front-end first queries the data segment storage to determines if any of the data segments representing the write data have been previously stored, for example as the result of previous data write operations including the one or more of the same data segments. The storage front-end stores any data segments that have not been previously stored along with their associated labels in the data segment storage. For data segments that have been previously stored in the data segment storage, an embodiment of the storage front-end updates label metadata in the data segment storage to indicate that an additional data layout is referencing these previously stored data segments.

As shown in FIG. 2, file system 200 separates the storage of file metadata from the storage of file data for improved efficiency, performance, and scalability. However, this may create problems when updating both the file data and file metadata. For example, some file data operations, for example changing the data in a file, may also cause changes in the file's associated metadata, for example updating the size or modified date metadata. With separate storage of file data and metadata, prior systems commonly use a complex and inefficient two-phase commit process to ensure that the updates to the file data and metadata are synchronized and intact.

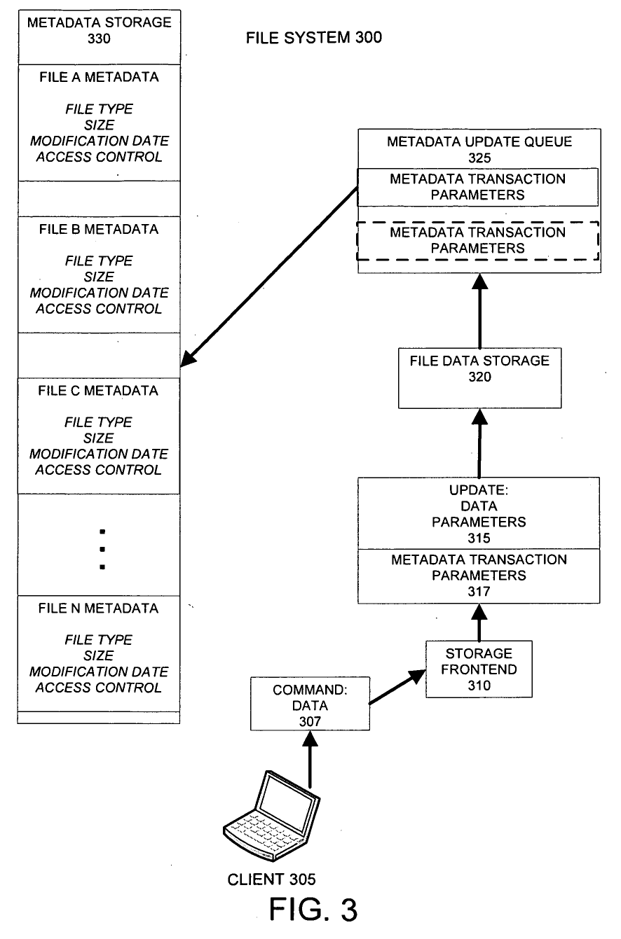

FIG. 3 illustrates an example 300 of updating data and metadata of a file system according to an embodiment of the invention. In example 300, a client 305 sends a command 307 to update or modify file data. This command is intercepted by the storage front-end 310, which converts it into a corresponding data storage command 315. Data storage command 315 is adapted to be processed by a file data storage system 320, which is similar to the file data storage 210 discussed above.

In an embodiment, data storage command 315 includes metadata transaction parameters 317. The metadata transaction parameters 317 are adapted to update the metadata associated with the file being updated by the data storage command 315. For example, if the command 307 is adapted to change the size of the file, then the corresponding data storage command 315 will include metadata transaction parameters 317 specifying changes in the file size and modified date attributes of the file's metadata.

In an embodiment, metadata transaction parameters 317 are generated by the storage front-end 310. In an alternate embodiment, a client 305 may be capable of communicating directly with the file data storage system 320. In this embodiment, the client generates the data storage command 315 and its metadata transaction parameters 317 directly and the command 307 and storage front-end 310 may be bypassed.

In an embodiment, the data storage command 315, including the metadata transaction parameters 317, is provided to the file data storage 320. In response to receiving the data storage command 315, the file data storage 320 attempts to modify the appropriate file data as specified by the data storage command 315. If the file data storage 320 is successful in executing the data storage command 315, the file data storage 320 provides the metadata transaction parameters 317 included with the data storage command 315 to a metadata update queue 325. In an embodiment, the metadata transaction parameters 317 are atomically committed to the metadata update queue 325 to ensure data integrity. Conversely, if the file data storage 320 is not successful in executing the data storage command 315, then the metadata transaction parameters 317 are discarded and an error or other response may be returned to the storage front-end 310 and/or the client 305. In an embodiment, the storage front-end 310 may respond to the command 307 of the client 305 following the completion of the data storage command 315 by file data storage 320, without waiting for the metadata transaction parameters 317 to be processed by the metadata storage 330. This allows storage commands that affect data and metadata to be processed faster than with two-phase commit methods.

The metadata update queue 325 temporarily stores one or more sets of metadata transaction parameters until these metadata transaction parameters are processed by the metadata storage 330. In an embodiment, the metadata update queue 325 is persistent and durable across system reboots to ensure reliability. In an embodiment, the metadata storage 330 retrieves each set of metadata transaction parameters in order of receipt from the metadata update queue 325. The metadata storage 330 processes each set of metadata transaction parameters to update the file metadata of one or more files. As a result of this processing by the metadata storage 330, the file metadata becomes synchronized with the state of the file data. In an embodiment, the file data storage 320 and metadata storage 330 operate in parallel to process incoming data update commands and previously queued metadata transaction parameters, respectively.

In an embodiment, the storage front-end 310 maintains the metadata update queue 325 in its memory. As described above, the storage front-end 310 sends the metadata update operation to the metadata storage 330 after responding to the client data command 307, thus improving performance as the client data command 307 does not have to wait for metadata operation to be processed by the metadata storage 330. In a further embodiment, the storage front-end 310 may recover unprocessed metadata transaction parameters in the metadata update queue following crashes or restarts. In this embodiment, following a restart, the storage front-end 310 automatically requests all pending metadata transaction parameters previously stored in the metadata update queue 325 from the data storage system. These pending metadata transaction parameters are then processed by the metadata storage system 330.

As discussed above, changing the structure of a file system, the arrangement of file data and metadata, and data transformations such as data duplication can improve the efficiency, performance, scalability, and even the reliability of data storage systems. However, applications and users typically expect to interact with more typically structured file systems and file data.

Because of this need, a storage front-end interfaces between the file system in its native format and users and applications. The storage front-end may present the data and metadata of the file system to clients as a virtual file system, such that the underlying structure and arrangement of data and metadata is hidden from users and applications. Instead, the storage front-end presents users and applications with a view of the file system data and metadata as a local or networked file system, such as an XFS, CIFS, or NFS file system. Because the storage front-end presents a virtual file system to one or more users or applications, depending upon the file system protocol, a user or application may believe that it is managing files and data on a raw volume directly. The storage front-end intercepts and processes all client commands to the virtual file system, accesses and optionally updates the data and metadata in the underlying file data and metadata storage in the native file system, and optionally provides a result back to the users or applications.

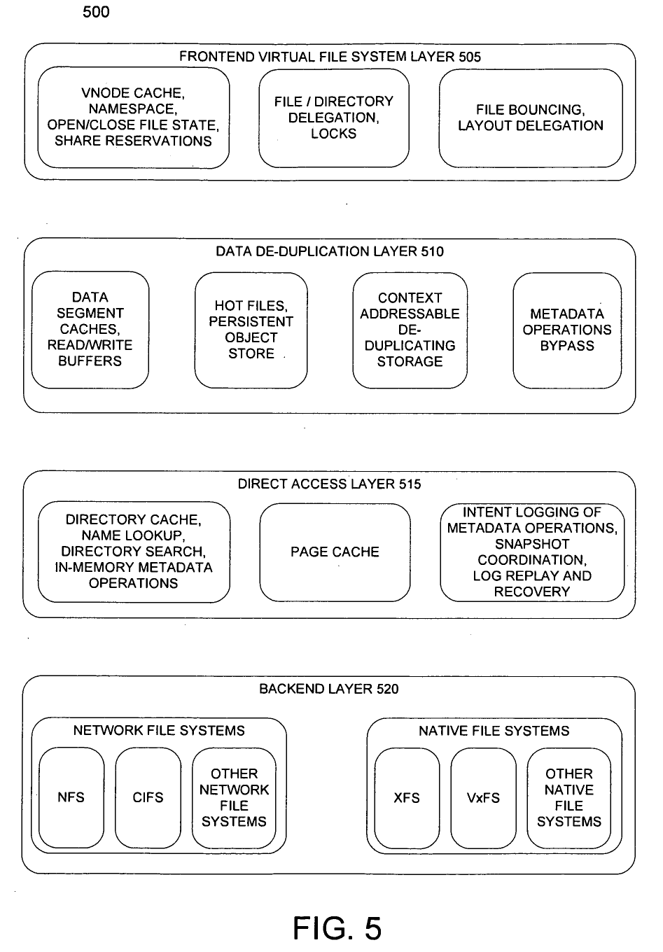

Because of the wide range of data and metadata processing, interfacing, caching, data transformation and compression, and numerous other operations to translate between the virtual file system and the underlying format of data, the storage front-end may be implemented as a stack of virtual file system modules. FIG. 5 illustrates a virtual file system stack 500 suitable for implementing file systems according to embodiments of the invention.

In an embodiment, virtual file system stack 500 includes at least one front-end virtual file system layer 505, a data deduplication layer 510, a direct access layer 515, and at least one backend layer 520. The virtual file system layer 505 maintains an in-memory state of the virtual file system, such as files that are open or locked. The virtual file system layer 505 also provides an interface to the virtual file to users and applications.

In a further embodiment, the virtual file system stack 500 includes one or more virtual file system layers that support multiple virtual file systems or other data storage interfaces. This allows for data storage and data transformations such as data deduplication to be consolidated over multiple file systems and data interfaces. For example, if two copies of the same file (or a portion thereof) are stored in separate virtual file systems, the underlying deduplicating data storage will only require one copy of the file data. Other data interfaces, such as e-mail server or database application interfaces, may be implemented by the virtual file system layer, allowing for further storage efficiencies. For example, if a file stored in a file system is e-mailed by a user, the e-mail server may maintain a copy of the e-mail message and the attached file. However, if the e-mail server's storage is implemented within the deduplicated file system, then no additional copies of the attached file are required.

Virtual file system stack 500 also includes a data deduplication layer 510. In an embodiment, data deduplication layer 510 performs data deduplication as described above to improve storage efficiency and performance. In an additional embodiment, data deduplication is implemented as described in related application (R000200US, entitled “Log Structured Content Addressable Deduplicating Storage), which is incorporated by reference herein for all purposes.

In addition to data deduplication layer 510, additional data processing and transformation layers may be included in this portion of the virtual file system stack 500 to improve performance, efficiency, reliability, or other aspects of the data storage system, and/or to perform other data processing functions, such as encryption or virus scanning.

Virtual file system stack 500 also includes direct access layer 515 adapted to cache the directory hierarchy and metadata. Direct access layer may also include a metadata update queue as described above for updating file metadata efficiently.

Virtual file system stack 500 includes at least one backend layer 520 providing an interface between modules in the virtual file system stack 500 and the underlying file system, such as a CIFS, NFS, or other network file system; or XFS, VxFS, or other native file system. Embodiments of virtual file system stack 500 may include one or more backend layers 520 adapted to interface with two or more underlying file systems, allowing two or more separate storage devices or networks to be considered as a single logical storage device or storage network.

One problem with using a file system stack such as virtual file system stack 500 is that each stack layer module may wish to include additional metadata with file data being processed. For example, the NTFS file system supports a “creation time” metadata attribute to indicate the creation time of a file object. However, file systems such as XFS do not natively support this metadata attribute. If a front-end virtual file system layer 505 provides a type of virtual file system to users and application, the underlying native file system needs to be able to support all the virtual file system's metadata attributes, even if the native file system is of a different type that does not provide similar metadata attributes.

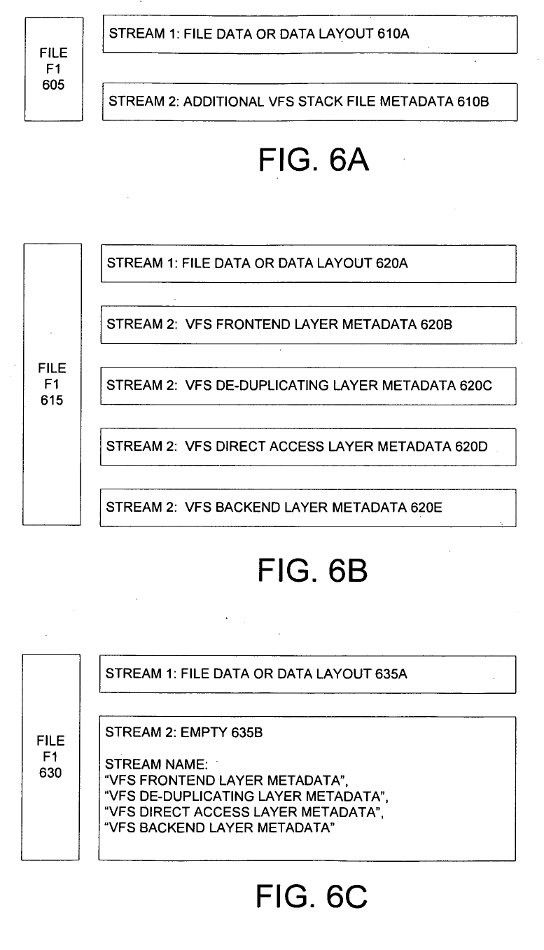

An embodiment of the invention supports arbitrary file metadata attributes in virtual file systems by storing file metadata attributes using one or more additional data streams of the file object. FIGS. 6A-6C illustrate storing virtual file system layer data in additional file data streams according to embodiments of the invention.

In one embodiment, a file object includes a single additional data stream adapted to store metadata attributes from one or more virtual file system stack layers. FIG. 6A illustrates an example file F1 605 including a first data stream 610a adapted to store file data or a corresponding data layout. A second data stream 610b stores additional file metadata from one or more virtual file system stack layers.

FIG. 6B illustrates an example file F1 615 including a first data stream 610a adapted to store file data or a corresponding data layout. In this example file F1 615, metadata from each virtual file system stack layer is stored in a separate data stream. For example, data streams 620b, 620c, 620d, and 620e store file metadata associated with the front-end layer 505, data deduplication layer 510, direct access layer 515, and backend layer 520, respectively.

In another embodiment, additional file metadata is stored using an additional data stream. However, the contents of this additional data stream remains empty. Instead, the additional file metadata is stored in the name of the additional data stream. This embodiment is useful when reading or writing additional data streams is slower or less efficient than reading or writing the name of an additional data stream. FIG. 6C illustrates an example file F1 630 including a first data stream 635a adapted to store file data or a corresponding data layout. A second data stream 635b is empty, but has its name set to the additional metadata attribute values provided by one or more virtual file system stack layers.

Additionally, data transformations performed by virtual file system stack layers may alter the metadata attributes of a file. For example, a data deduplication layer reduces the size of file data. Accordingly, the file size metadata attribute for this file should be reduced. However, many file system operations require metadata access. If the metadata attributes of a file have been changed due to a data transformation, such as data deduplication, then the expected original file metadata attribute values will need to be reconstructed by the storage front-end.

For example, if an application requests the file size of a file that has been reduced in size using data deduplication, the storage front-end should provide the size of the original file to the application, not the actual size of the deduplicated file on disk. Otherwise, the application may not function correctly. In this case, the storage front-end would have to reconstruct the original file from its data layout and the data segment storage to determine the original file size. This operation is inefficient and may be time-consuming, especially if the application does not actually require access to the original file data.

To improve efficiency in accessing metadata attributes, an embodiment of the invention sets the file size attribute or other metadata attributes of a transformed data file to the attribute values of the untransformed file. For example, the file size attribute of a deduplicated file may be set to the file size of the original uncompressed file. Many file systems, such as NTFS and XFS, allow for the creation of sparse files. A sparse file may have a file size attribute set independently of the actual size of the data in the file. In a sparse file, the file system allocates space for the file as needed.

Because the metadata attributes of transformed files are set to the values of their untransformed files, a storage front-end may determine the metadata attributes of untransformed files simply by accessing the metadata of their corresponding transformed files. Little or no intermediate processing or data transformation is required.

Embodiments of the invention may be implemented in a variety of forms. For example, an embodiment of the invention may include a storage front-end software and/or hardware adapted to provide one or more virtual file systems and associated interfaces to third-party users and applications, and to interface with one or more third-party data storage devices or storage area networks. In a further embodiment, storage front-end and/or a virtual file system stack may be integrated with one or more data storage devices or storage area networks.

Another embodiment of the invention may be implemented as portions of the above-described virtual file system stack, such as a data deduplication layer module, a direct access layer module, or other data transformation layer modules. In this embodiment, the modules including embodiments of the invention are adapted to interface with other third-party modules to form a complete virtual file system stack.

In still further embodiments, the data segmentation and deduplication may be integrated with wide-area network (WAN) acceleration, such as that described in co-pending patent application “Hybrid Segment-Oriented File Server and WAN Accelerator, U.S. patent application Ser. No. 12/117,269, filed May 8, 2008. In these embodiments, the data deduplication storage and WAN acceleration systems use the same type of segmentation scheme to minimize data redundancy. The data deduplicating storage and the WAN acceleration systems communicate using a segment-oriented file system (SFS) protocol adapted to specify data in the form of segments. This allows more efficient storage and communication of data, especially over wide-area networks.

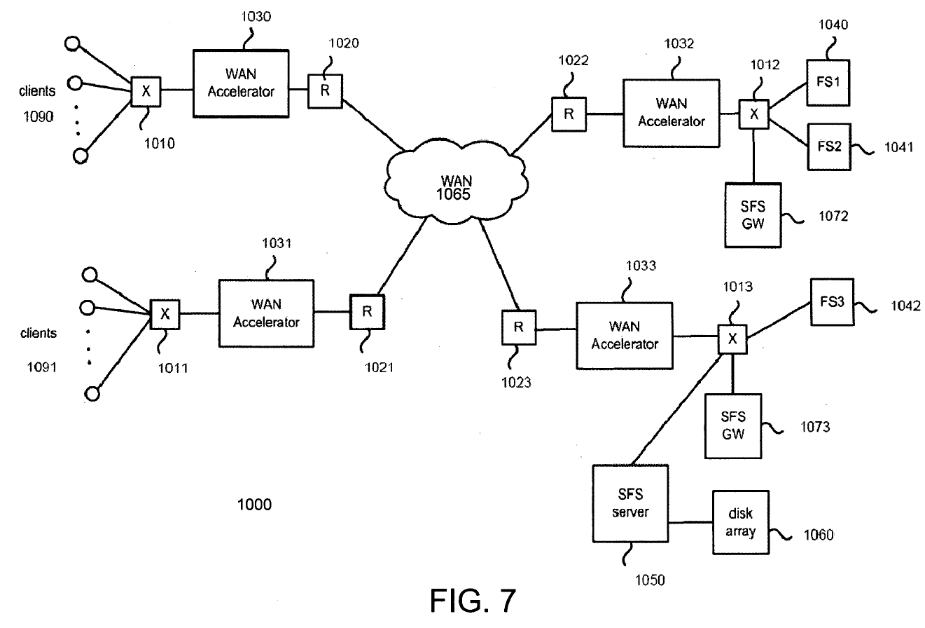

FIG. 7 illustrates an example hybrid WAN acceleration and deduplicating data storage system 1000 suitable for use with embodiments of the invention. FIG. 7 depicts one configuration including two segment-orientated file server (SFS) gateways and an SFS server situated at two different sites in a network along with WAN accelerators configured at each site. In this configuration, clients in groups 1090 and 1091 access files ultimately stored on file servers 1040, 1041, and 1042. Local area networks 1010, 1011, 1012, and 1013 provide data communications between clients, SFS gateways, SFS servers, file servers, WAN accelerators, wide-area networks, and other devices. Local area networks 1010, 1011, 1012, and 1013 may include switches, hubs, routers, wireless access points, and other local area networking devices. Local area networks are connected via routers 1020, 1021, 1022, and 1023 with a wide-area network (WAN).

The clients may access files and data directly using native file server protocols, like CIFS and NFS, or using data interfaces, such as database protocols. In the case of file server protocols, local or remote clients access file and data by mounting a file system or “file share.” Each file system may be a real file system provided by a file server such as file servers 1040, 1041, and 1042, or a virtual file system provided by a SFS gateway or storage front-end, such as SFS gateways 1072 and 1073. Once a file system is mounted via a transport connection, files can be accessed and manipulated over that connection by applications or file system tools invoked by the user. Traditionally, these protocols have performed poorly over the WAN but are accelerated by the WAN accelerators present in the network.

For example, a client in group 1091 might access file server 1040 and WAN accelerators 1030 and 1032 would optimize that file server connection, typically providing “LAN-like” performance over the WAN using techniques as those described in U.S. Pat. No. 7,120,666 entitled “Transaction Accelerator for Client-Server Communication Systems”; U.S. Pat. No. 6,667,700 entitled “Content-Based Segmentation Scheme for Data Compression in Storage and Transmission Including Hierarchical Segment Representation”; and U.S. Patent Publication 2004/0215746, published Oct. 28, 2004 entitled “Transparent Client-Server Transaction Accelerator”, which are incorporated by reference herein for all purposes.

If a client, for example, from group 1091, mounts one of the exported file systems located on SFS gateway 1073 via a transport connection including WAN 1065, WAN accelerators 1031 and 1033 will optimize network traffic for passage through WAN 1065. In an embodiment, each of the WAN accelerators 1031 and 1033 will partition network traffic into data segments, similar to those described above. WAN accelerators 1031 and 1033 will cache frequently used data segments.

In an example of prior systems, when one of the clients 1090 requests a file, WAN accelerator 1032 reads the requested file from a file system and partitions the file into data segments. WAN accelerator 1032 determines the data layout or set of data segments comprising the requested file. WAN accelerator 1032 communicates the data layout of the requested file to WAN accelerator 1030, which in turn attempts to reconstruct the file using the data layout provided by WAN accelerator 1032 and its cached data segments. Any data segments required by a data layout and not cached by WAN accelerator 1030 may be communicated via WAN 165 to WAN accelerator 1030.

Further benefits are achieved, however, by arranging for clients to access the files stored on file servers 1040, 1041 and 1042 via the SFS gateways 1072 and 1073 or SFS server 1050. In this scenario, SFS gateways 1072 and 1073 export one or more virtual file systems. The SFS gateways 1072 and 1073 may implement data deduplicated storage using the file servers 1040 and/or 1041 to store data segments, data layouts, and file or other metadata.

To improve performance, an embodiment of system 1000 allows WAN accelerators to access data segments and data layouts directly in deduplicating data storage using a SFS protocol. In this embodiment, when one of the clients 1090 requests a file, WAN accelerator 1032 accesses a SFS gateway, such as SFS gateways 1072 and 1073, or a SFS server, such as SFS server 1050, to retrieve the data layout of the requested file directly. WAN accelerator 1032 then communicates this data layout to WAN accelerator 1030 to reconstruct the requested file from its cached data segments. The advantage to this approach is that WAN accelerator 1030 does not have to read the entire requested file and partition it into data segments; instead, the WAN accelerators leverage the segmentation and data layout determinations already employed by the data deduplicating storage.

Furthermore, if WAN accelerator 1030 requires data segments that are not locally cached to reconstruct some or all of the requested file, WAN accelerator 1032 can retrieve these additional data segments from an SFS gateway or SFS server using a SFS protocol. In this example, WAN accelerator 1032 may retrieve one or more data segments from a file system or SFS server using their associated labels or other identifiers, without requiring any reference to any data layouts or files.

The benefits of the SFS architecture can accrue to an SFS file server as depicted in FIG. 7, whereby SFS server 1050 is interconnected to disk array 1060. In an embodiment, the SFS server acts as a combination of a SFS gateway and an associated file server or data storage system. For example, SFS server 1050 manages its own file system on a raw volume directly, e.g., located on a disk array and accessed via iSCSI or Fibre channel over a storage-area network (SAN). In this scenario, there is no need for backend file servers, because the SFS server 1050 implements or interfaces with its own data storage system. The SFS server 1050 may include an external disk array as depicted, such as a storage area network, and/or include internal disk-based storage.

The SFS server 1050 is configured by an administrator to export one or more virtual file systems or other data interfaces, such as database or e-mail server APIs. Then, a client, for example, from group 1090 mounts one of the exported virtual file systems or interfaces located on SFS server 1050 via a transport connection. This transport connection is then optimized by WAN accelerators 1030 and 1033. Furthermore, because these WAN accelerators are SFS-aware, they intercommunicate with SFS server 1050 using SFS rather than a legacy file protocol like CIFS or NFS. In turn, the SFS server stores all of the data associated with the file system on its internal disks or external storage volume over a SAN.

In a further embodiment, the data deduplication storage system may leverage the use of WAN accelerators to partition incoming data into data segments and determine data layouts. For example, if one of the clients 1090 attempts to write a new file to the storage system, WAN accelerator 1030 will receive the entire file from the client. WAN accelerator 1030 will partition the received file into data segments and a corresponding data layout. WAN accelerator 1030 will send the data layout of this new file to WAN accelerator 1032. WAN accelerator 1030 may also send any new data segments to WAN accelerator 1032 if copies of these data segments are not already in the data storage. Upon receiving the data layout of the new file, WAN accelerator 1032 stores the data layout and optionally file metadata in the data deduplicating file system. Additionally, WAN accelerator 1032, a SFS gateway, and/or a SFS server issues one or more segment operations to store new data segments and to update reference counts and other label metadata for all of the data segments referenced by the new file's data layout. By using WAN accelerator 1030 to partition data, the processing workload of the SFS gateways or SFS server in a data deduplicating storage system is substantially reduced.

Similarly, if a client is directly connected with local area network 1012, rather than connecting through LAN 165, an embodiment of a SFS gateway or SFS server redirects all incoming data from the local client to a local WAN accelerator, such as WAN accelerator 1032, for partitioning into data segments and for determining the data layout.

Further embodiments can be envisioned to one of ordinary skill in the art. In other embodiments, combinations or sub-combinations of the above disclosed invention can be advantageously made. The block diagrams of the architecture and flow charts are grouped for ease of understanding. However it should be understood that combinations of blocks, additions of new blocks, re-arrangement of blocks, and the like are contemplated in alternative embodiments of the present invention.

The specification and drawings are, accordingly, to be regarded in an illustrative rather than a restrictive sense. It will, however, be evident that various modifications and changes may be made thereunto without departing from the broader spirit and scope of the invention as set forth in the claims.

1.-16. (canceled)

17. A method of storing data in a data storage system, the method comprising:
receiving a file including file metadata and file data in a first file data format to be stored in the data storage system;
transforming the file data into transformed file data and a data transformation layout, wherein the data transformation layout specifies an arrangement of the transformed file data that replicates the file data in the first file data format;
storing the file metadata in a first data storage in the first file data format;
storing the data transformation layout in the first data storage in the first file data format; and
storing at least a portion of the transformed file data in a second data storage.

18. The method of claim 17, wherein the first data storage includes a file system adapted to store file metadata and file data in the file data format.

19. The method of claim 18, wherein storing the data transformation layout comprises storing the data transformation layout in a file data stream.

20. The method of claim 19, wherein the file data stream is associated with a main data stream of a file.

21. The method of claim 19, wherein the file data stream is associated with an alternate data stream of a file.

22. The method of claim 17, wherein the second data storage is adapted to store the transformed file data.

23. The method of claim 17, wherein the data transformation layout includes at least one data segment label based on at least one hash of at least a portion of the file data.

24. A method of accessing data from a data storage system, the method comprising:
receiving a storage command;
determining if the storage command is associated with a metadata request;
in response to the determination that the storage command is associated with the metadata request, retrieving file system metadata included in a file system;
determining if the storage command is associated with a file data access;
in response to the determination that the storage command is associated with the file data access, retrieving a data transformation layout from the file system; and
retrieving transformed file data referenced by the data transformation layout from a second data storage.

25. The method of claim 24, comprising:
arranging the transformed file data according to the data transformation layout to replicate file data associated with the file system.

26. The method of claim 24, wherein the file system metadata includes a path in the file system.

27. The method of claim 24, wherein the file system metadata includes an attribute of a file included the file system.

28. The method of claim 24, wherein the storage command is associated with a file included in the file system.

29. The method of claim 28, wherein the data transformation layout is retrieved from an additional data stream associated with the file.

30. The method of claim 28, wherein the data transformation layout is retrieved from the file.

31. A computer-readable storage medium including instructions adapted to direct a computer to perform an operation, the operation comprising:
receiving a file including file metadata and file data in a first file data format to be stored in the data storage system;
transforming the file data into transformed file data and a data transformation layout, wherein the data transformation layout specifies an arrangement of the transformed file data that replicates the file data in the first file data format;
storing the file metadata in a first data storage in the first file data format;
storing the data transformation layout in the first data storage in the first file data format; and
storing at least a portion of the transformed file data in a second data storage.

32. The computer-readable storage medium of claim 31, wherein the first data storage includes a file system adapted to store file metadata and file data in the file data format.

33. The computer-readable storage medium of claim 32, wherein storing the data transformation layout comprises storing the data transformation layout in a file data stream.

34. The computer-readable storage medium of claim 31, wherein the second data storage is adapted to store the transformed file data.

35. The computer-readable storage medium of claim 31, wherein the data transformation layout includes at least one data segment label based on at least one hash of at least a portion of the file data.

36. A computer-readable storage medium including instructions adapted to direct a computer to perform an operation, the operation comprising:
receiving a storage command;
determining if the storage command is associated with a metadata request;
in response to the determination that the storage command is associated with the metadata request, retrieving file system metadata included in a file system;
determining if the storage command is associated with a file data access;
in response to the determination that the storage command is associated with the file data access, retrieving a data transformation layout from the file system; and
retrieving transformed file data referenced by the data transformation layout from a second data storage.

37. The computer-readable storage medium of claim 36, comprising:
arranging the transformed file data according to the data transformation layout to replicate file data associated with the file system.

38. The computer-readable storage medium of claim 36, wherein the file system metadata includes a path in the file system.

39. The computer-readable storage medium of claim 36, wherein the storage command is associated with a file included in the file system.

40. The computer-readable storage medium of claim 39, wherein the data transformation layout is retrieved from an additional data stream associated with the file.

41. The computer-readable storage medium of claim 39, wherein the data transformation layout is retrieved from the file.
